(19) United States
(12) Patent Application Publication
(10) Pub. No.: US 2017/0078253 A1
(43) Pub. Date: Mar. 16, 2017

(54) INFORMATION PROCESSING SYSTEM, SERVER DEVICE, AND NON-TRANSITORY COMPUTER-READABLE MEDIUM

(71) Applicant: Atsuhisa SAITOH, Kanagawa (JP)

(72) Inventor: Atsuhisa SAITOH, Kanagawa (JP)

(73) Assignee: Ricoh Company, Ltd., Tokyo (JP)

(21) Appl. No.: 15/258,351

(22) Filed: Sep. 7, 2016

(30) Foreign Application Priority Data
Sep. 14, 2015 (JP) 2015-181249

(51) Int. Cl. H04L 29/06; G06Q 50/22; G06F 21/62; H04L 9/14; H04L 9/30

(52) U.S. Cl. CPC H04L 63/0428; H04L 9/14; H04L 9/30; H04L 63/06; G06F 21/6245; G06Q 50/22

(57) ABSTRACT

A server device that is a first-facility terminal device configured to transmit issuance information issued by a first facility to a user terminal device of a user of the first facility, includes: a first-facility encrypting unit configured to encrypt the issuance information issued by the first facility using a public key acquired from the user terminal device, and a first-facility terminal transmitting unit configured to transmit, when the user terminal device is connected to a network to which the first-facility terminal device is connected, the issuance information without encryption to the user terminal device, and to transmit, when the user terminal device is not connected to the network, the encrypted issuance information to the user terminal device.

### CROSS-REFERENCE TO RELATED APPLICATIONS

The present application claims priority under 35 U.S.C. §119 to Japanese Patent Application No. 2015-181249, filed Sep. 14, 2015. The contents of which are incorporated herein by reference in their entirety.

### BACKGROUND OF THE INVENTION

1. Field of the Invention

The present invention relates to an information processing system, a server device, and a non-transitory computer-readable medium.

2. Description of the Related Art

Today a medical information system is known, in which by making prescriptions and the like issued by medical facilities into electronic data and transmitting the electronic data to pharmacies, etc., it is possible to securely deliver the prescriptions and the like. Japanese Unexamined Patent Application Publication No. 2002-245162 discloses a system in which a prescription ID recorded in an electronic patient ID card is used instead of a paper prescription to enable electronic transmission of a prescription and to digitize medical service operations including medical examination reservation, for the purpose of efficiency, speeding up, and accuracy of medical service.

However, the conventional medical information systems including the system disclosed in Japanese Unexamined Patent Application Publication No. 2002-245162 are required to previously connect between hospitals and pharmacies with a secure network. Therefore, there is a problem that system construction becomes troublesome.

### SUMMARY OF THE INVENTION

According to an aspect of the present invention, there is provided an information processing system including at least a first-facility terminal device of a first facility and a user terminal device of a user of the first facility, wherein the first-facility terminal device is configured to include: a first-facility encrypting unit configured to encrypt issuance information issued by the first facility using a public key acquired from the user terminal device, and a first-facility terminal transmitting unit configured to transmit, when the user terminal device is connected to a network to which the first-facility terminal device is connected, the issuance information without encryption to the user terminal device, and to transmit, when the user terminal device is not connected to the network, the encrypted issuance information to the user terminal device, and the user terminal device is configured to include: a user-terminal transmitting unit configured to transmit the public key of the user terminal device to the first-facility terminal device, a user-terminal receiving unit configured to receive the issuance information not encrypted or the encrypted issuance information transmitted from the first-facility terminal device, and a user-terminal decrypting unit configured to decrypt the encrypted issuance information using a private key that is paired with the public key.

According to another aspect of the present invention, there is provided a server device that is a first-facility terminal device configured to transmit issuance information issued by a first facility to a user terminal device of a user of the first facility, including: a first-facility encrypting unit configured to encrypt the issuance information issued by the first facility using a public key acquired from the user terminal device, and a first-facility terminal transmitting unit configured to transmit, when the user terminal device is connected to a network to which the first-facility terminal device is connected, the issuance information without encryption to the user terminal device, and to transmit, when the user terminal device is not connected to the network, the encrypted issuance information to the user terminal device.

According to still another aspect of the present invention, there is provided a non-transitory computer-readable medium comprising computer readable program codes, performed by a processor, the program codes when executed causing the processor to execute: encrypting issuance information issued by a first facility using a public key acquired from a user terminal device, and transmitting, when the user terminal device is connected to a network to which a first-facility terminal device is connected, the issuance information without encryption to the user terminal device, and transmitting, when the user terminal device is not connected to the network, the encrypted issuance information to the user terminal device.

### BRIEF DESCRIPTION OF THE DRAWINGS

FIG. 1 is a system configuration diagram of a medical information processing system according to a first embodiment;

FIG. 2 is a hardware configuration diagram of a server device of a hospital (and a terminal device of a pharmacy);

FIG. 3 is a hardware configuration diagram of a mobile terminal;

FIG. 4 is a functional block diagram of the functions implemented by a CPU of the server device of the hospital executing a medical processing program;

FIG. 5 is a functional block diagram of the functions implemented by a CPU of a terminal device provided in each pharmacy executing a medical processing program;

FIG. 6 is a functional block diagram of the functions implemented by a CPU of a mobile terminal owned by each patient executing a medical processing program;

FIG. 7 is a sequence diagram illustrating a flow of communication performed by a mobile terminal located in a predetermined network with the server device of the hospital and with terminal devices of pharmacies;

FIG. 8 is a diagram illustrating a screen example of the mobile terminal;

FIG. 9 is a diagram illustrating a screen example of the mobile terminal at the time of registering the mobile terminal in the terminal device of a pharmacy;

FIG. 10 is a diagram illustrating a screen example of the mobile terminal at the time of registering the mobile terminal in the server device of the hospital;

FIG. 11 is a diagram illustrating a selection screen for selecting processing for notification from the hospital when the mobile terminal is located outside the predetermined network;

FIG. 12 is a diagram illustrating a notification screen when the pharmacy notifies the mobile terminal that the pharmacy receives the prescription from the hospital;

FIG. 13 is a diagram illustrating a notification screen when the pharmacy having received the prescription from the hospital notifies the mobile terminal that preparation of the medicine notified thereto is completed (dispensing completed);

FIG. 14 is a sequence diagram illustrating a flow of communication performed by the mobile terminal located outside a wireless LAN of the hospital with the server device of the hospital and with the terminal devices of the pharmacies;

FIG. 15 is a diagram illustrating a selection screen used when the mobile terminal located within the wireless LAN of the hospital selects the way to receive prescription data;

FIG. 16 is a diagram illustrating a screen example of displaying a mail result for reception of the prescription data;

FIG. 17 is a sequence diagram illustrating a flow of transmission of the prescription data created by the hospital from the mobile terminal to a desired pharmacy;

FIG. 18 is a diagram illustrating a receipt notification screen of the mobile terminal having received the prescription data from the hospital;

FIG. 19 is a diagram illustrating a selection screen of pharmacies within the wireless LAN where the mobile terminal is located;

FIG. 20 is a diagram illustrating a selection screen of the prescription data to be transmitted to a pharmacy;

FIG. 21 is a diagram illustrating an operation screen used to transmit the selected prescription data to the selected pharmacy;

FIG. 22 is a system configuration diagram of a medical information processing system according to a second embodiment;

FIG. 23 is a hardware configuration diagram of a cloud server device;

FIG. 24 is a functional block diagram of a server device in a hospital side provided in the medical information processing system according to the second embodiment;

FIG. 25 is a functional block diagram of the cloud server device;

FIG. 26 is a sequence diagram illustrating a flow of transmission of prescription data to the terminal device of a pharmacy via the cloud server device;

FIG. 27 is a diagram illustrating a selection screen for cloud server devices;

FIG. 28 is a diagram illustrating a registration confirmation screen of the cloud server device;

FIG. 29 is a diagram illustrating a selection screen for a destination of prescription data;

FIG. 30 is a diagram illustrating a selection screen for a pharmacy as a destination of prescription data requested to a cloud server device;

FIG. 31 is a diagram illustrating a confirmation screen of the cloud server device to which transmission of the prescription data is requested; and

FIG. 32 is a diagram illustrating a confirmation screen of a pharmacy to which the prescription data is transmitted from the cloud server device.

The accompanying drawings are intended to depict exemplary embodiments of the present invention and should not be interpreted to limit the scope thereof. Identical or similar reference numerals designate identical or similar components throughout the various drawings.

### DETAILED DESCRIPTION OF THE PREFERRED EMBODIMENTS

The terminology used herein is for the purpose of describing particular embodiments only and is not intended to be limiting of the present invention.

As used herein, the singular forms “a”, “an” and “the” are intended to include the plural forms as well, unless the context clearly indicates otherwise.

In describing preferred embodiments illustrated in the drawings, specific terminology may be employed for the sake of clarity. However, the disclosure of this patent specification is not intended to be limited to the specific terminology so selected, and it is to be understood that each specific element includes all technical equivalents that have the same function, operate in a similar manner, and achieve a similar result.

An embodiment of the present invention will be described in detail below with reference to the drawings.

The present invention has an object to provide an information processing system, a server device, and a non-transitory computer-readable medium capable of transmitting and receiving digitized medical information easily and securely.

### First Embodiment

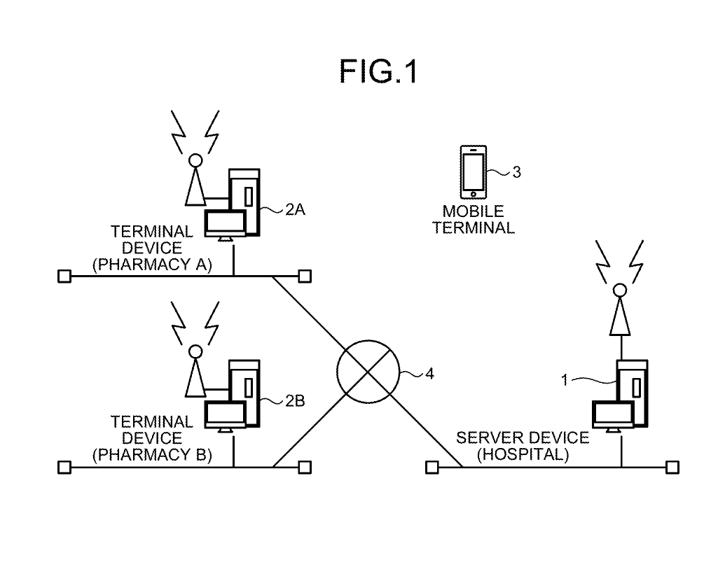

FIG. 1 is a system configuration diagram of a medical information processing system according to a first embodiment. As illustrated in FIG. 1, the medical information processing system includes a server device 1 as an example of a first-facility terminal device provided in a hospital side as an example of a first facility, terminal devices 2A and 2B provided in a pharmacy side as an example of a second facility, and a mobile terminal 3 owned by a patient (user). The hospital is an example of the first facility. The server device 1 is an example of the first-facility terminal device. The mobile terminal 3 is an example of a user terminal device. The server device 1 through the mobile terminal 3 may be one or two or more. In this example, there are two pharmacies, each of which is provided with either the terminal device 2A or the terminal device 2B. However, if it is not necessary to distinguish between the two in explanation, they are explained as “terminal device 2”.

The server device 1 of the hospital that issues prescriptions of patients is connected with the terminal devices 2A and 2B of pharmacies that dispense prescriptions through a wide area network (WAN) such as Internet 4. The server device 1 of the hospital and the terminal devices 2A and 2B of pharmacies have wireless LAN access points, which enable wireless communication with the mobile terminal 3 of the patient.

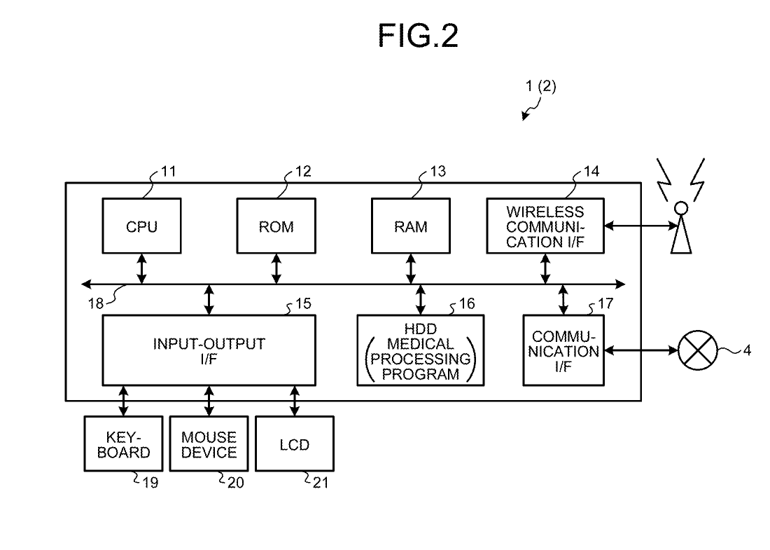

FIG. 2 is a hardware configuration diagram of the server device 1 of the hospital (and the terminal device 2 of a pharmacy). As illustrated in FIG. 2, the server device 1 includes a central processing unit (CPU) 11, a read-only memory (ROM) 12, a random access memory (RAM) 13, a wireless communication interface (I/F) 14, an input-output I/F 15, a hard disk drive (HDD) 16, and a communication I/F 17. The CPU 11 through the communication I/F 17 are connected to each other through a system bus 18. The input-output I/F 15 is connected with a keyboard 19, a mouse device 20, and a liquid crystal display (LCD) 21. In other words, the server device 1 of the hospital (and the terminal device 2 of a pharmacy) has a configuration of an ordinary computer device.

The HDD 16 stores the medical processing program as an example of the information processing program. The CPU 11 executes the medical processing program and can thereby securely transmit and receive the prescription data, etc. as an example of issuance information, which will be explained later, between the hospital, the pharmacies, and the patient.

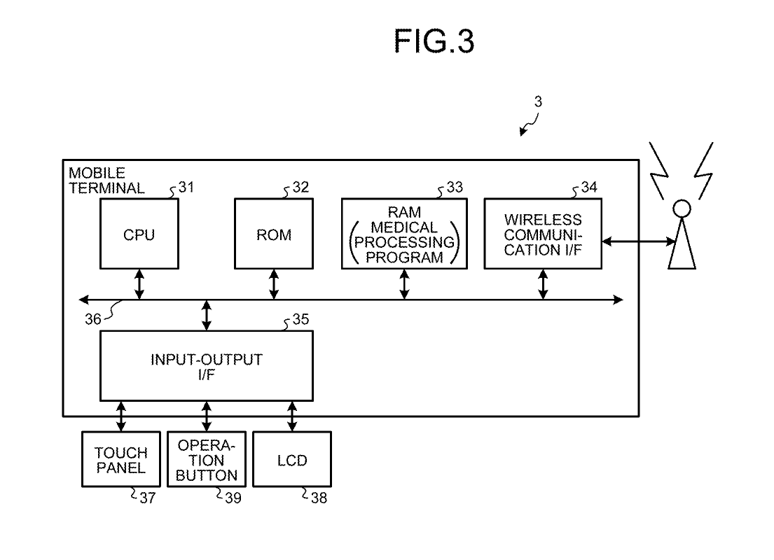

FIG. 3 is a hardware configuration diagram of the mobile terminal 3. As illustrated in FIG. 3, the mobile terminal 3 includes a CPU 31, a ROM 32, a RAM 33, a wireless communication I/F 34, and an input-output I/F 35. The CPU 31 through the input-output I/F 35 are connected to each other through a system bus 36. The input-output I/F 35 is connected with a touch panel 37, an LCD 38, and an operation button 39.

The RAM 33 stores the medical processing program as an example of the information processing program. The CPU 31 executes the medical processing program and can thereby securely transmit and receive the prescription data, etc., which will be explained later, between the hospital, the pharmacies, and the patient.

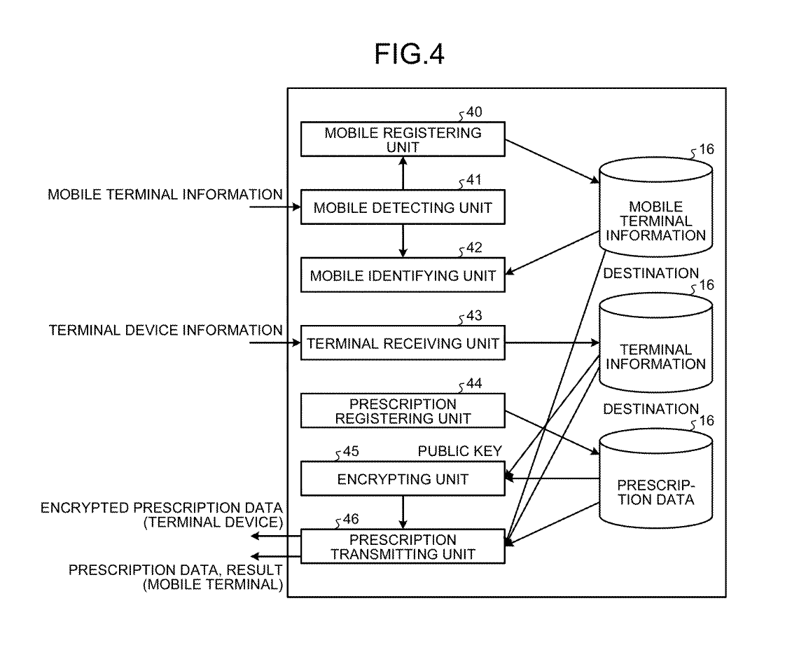

FIG. 4 is a functional block diagram of the functions implemented by the CPU 11 of the server device 1 of the hospital executing a medical processing program. As illustrated in FIG. 4, the CPU 11 executes the medical processing program to thereby implement a mobile registering unit 40, a mobile detecting unit 41, a mobile identifying unit 42, a terminal receiving unit 43, a prescription registering unit 44, an encrypting unit 45, and a prescription transmitting unit 46. The CPU 11 executes the medical processing program, and thereby mobile terminal information of each patient, terminal information of each pharmacy, and prescription data of each patient are dealt with through the HDD 16.

The mobile registering unit 40 registers (stores) the mobile terminal information of each patient in the HDD 16. The mobile detecting unit 41 receives the mobile terminal information from the outside and detects the mobile terminal 3. The mobile identifying unit 42 refers to the mobile terminal information stored in the HDD 16 based on the detected mobile terminal information to identify the mobile terminal 3.

The terminal receiving unit 43 receives the terminal information of the terminal device 2 of each pharmacy and stores the received terminal information in the HDD 16.

The prescription registering unit 44 stores the prescription data in the HDD 16. The encrypting unit 45 is an example of an facility encrypting unit, which encrypts the prescription data read from the HDD 16 using a public key of the terminal device 2. The prescription transmitting unit 46, which is an example of a first-facility terminal transmitting unit, transmits the encrypted prescription data to a destination of the pharmacy read from the HDD 16. The prescription transmitting unit 46 also transmits the transmission result to a destination of the patient read from the HDD 16.

In this example, the description of the mobile registering unit 40 through the prescription transmitting unit 46 will be continued assuming that they are implemented by software being the medical processing program. However, part or all of the mobile registering unit 40 through the prescription transmitting unit 46 may be implemented by hardware such as an integrated circuit (IC).

The medical processing program executed by the server device 1 may be provided by being recorded in a computer-readable recording medium such as a compact disk read only memory (CD-ROM) and a flexible disk (FD) in a file of an installable format or of an executable format. Moreover, the medical processing program may be provided by being recorded in a computer-readable recording medium such as a compact disk recordable (CD-R), a DVD, a Blu-ray disc (registered trademark), and a semiconductor memory. The DVD is an abbreviation for “Digital Versatile Disk”. The medical processing program executed by the server device 1 may be provided by being installed via a network such as the Internet. In addition, the medical processing program executed by the server device 1 may be provided by being preinstalled into a ROM or the like in the device.

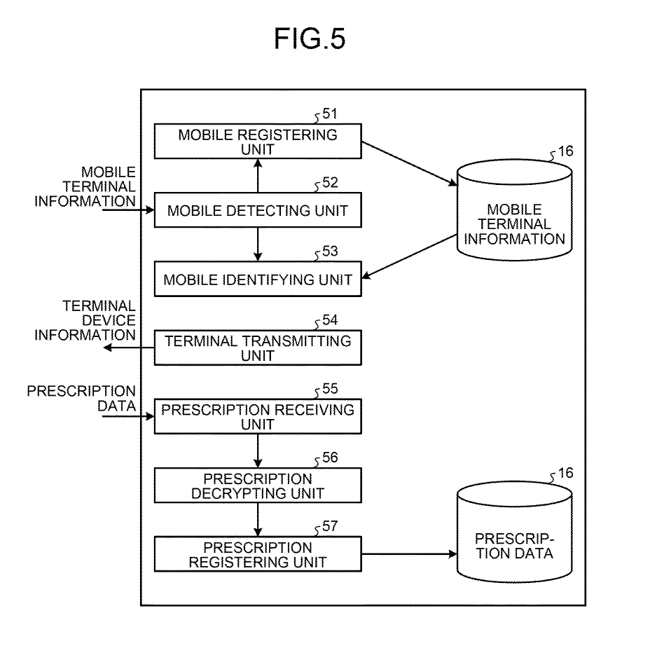

FIG. 5 is a functional block diagram of the functions implemented by the CPU 11 of the terminal device 2 provided in each pharmacy executing a medical processing program as an example of the information processing program. As illustrated in FIG. 5, the CPU 11 executes the medical processing program to thereby implement a mobile registering unit 51, a mobile detecting unit 52, a mobile identifying unit 53, a terminal transmitting unit 54, a prescription receiving unit 55, a prescription decrypting unit 56, and a prescription registering unit 57. The CPU 11 executes the medical processing program, and thereby the mobile terminal information of each patient and the prescription data of each patient are dealt with through the HDD 16.

The mobile registering unit 51 transmits information owned by the terminal device 2 (phone number and mail address of the pharmacy, and public key of the terminal device). The mobile detecting unit 52 receives mobile terminal information from the outside and detects a mobile terminal. The mobile identifying unit 53 refers to the mobile terminal information stored in the HDD 16 based on the detected mobile terminal information, to identify the detected mobile terminal 3. The prescription receiving unit 55 receives the prescription data and encrypted prescription data transmitted from the outside. The prescription decrypting unit 56, which is an example of a second-facility decrypting unit, decrypts the encrypted prescription data when it is received, using a private key of the terminal device. The prescription registering unit 57 registers (stores) the decrypted prescription data in the HDD 16.

In this example, the description of the mobile registering unit 51 through the prescription registering unit 57 will be continued assuming that they are implemented by software being the medical processing program. However, part or all of the mobile registering unit 51 through the prescription registering unit 57 may be implemented by hardware such as an IC.

The medical processing program executed by the terminal device 2 may be provided by being recorded in a computer-readable recording medium such as a CD-ROM and an FD in a file of an installable format or of an executable format. Moreover, the medical processing program may be provided by being recorded in a computer-readable recording medium such as a CD-R, a DVD, a Blu-ray disc (registered trademark), and a semiconductor memory. The DVD is an abbreviation for “Digital Versatile Disk”. The medical processing program executed by the terminal device 2 may be provided by being installed via a network such as the Internet. In addition, the medical processing program executed by the terminal device 2 may be provided by being preinstalled into a ROM or the like in the device.

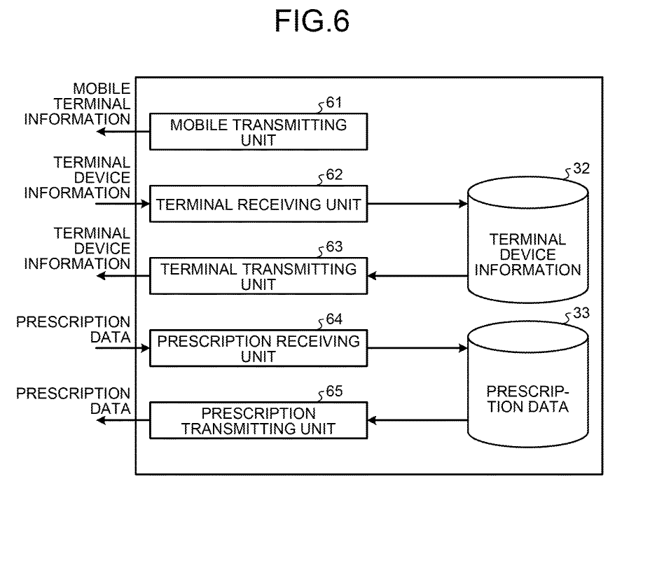

FIG. 6 is a functional block diagram of the functions implemented by the CPU 31 of the mobile terminal 3 owned by each patient executing a medical processing program. As illustrated in FIG. 6, the CPU 31 executes the medical processing program to thereby implement a mobile transmitting unit 61, a terminal receiving unit 62, a terminal transmitting unit 63, a prescription receiving unit 64, and a prescription transmitting unit 65. The CPU 31 executes the medical processing program, and thereby terminal device information of each pharmacy and the prescription data of the patient as an owner of the mobile terminal 3 are dealt with through the RAM 33.

The mobile transmitting unit 61, which is an example of a user-terminal transmitting unit, transmits information for specifying the mobile terminal 3, such as a phone number or a mail address of the mobile terminal. The terminal receiving unit 62, which is an example of a user-terminal receiving unit, receives the terminal device information from the outside and stores it in the RAM 33. The terminal receiving unit 62, which is also an example of a public key acquiring unit, acquires a public key from the terminal device 2 of a pharmacy and stores it in the RAM 33. The terminal transmitting unit 63 reads the terminal device information from the RAM 33 and transmits it to the outside. The prescription receiving unit 64, which is an example of a user terminal decrypting unit, receives the prescription data which is not encrypted or is encrypted transmitted from the server device 1 of the hospital and stores it in the RAM 33. When receiving the encrypted prescription data, the prescription receiving unit 64 uses the private key that is paired with the public key of the server device 1 of the hospital to decrypt the received prescription data. The prescription transmitting unit 65 reads the prescription data from the RAM 33 and transmits it to the outside.

In this example, the description of the mobile transmitting unit 61 through the prescription transmitting unit 65 will be continued assuming that they are implemented by software being the medical processing program. However, part or all of the mobile transmitting unit 61 through the prescription transmitting unit 65 may be implemented by hardware such as an IC.

The medical processing program executed by the mobile terminal 3 may be provided by being recorded in a computer-readable recording medium such as a CD-ROM and an FD in a file of an installable format or of an executable format. Moreover, the medical processing program may be provided by being recorded in a computer-readable recording medium such as a CD-R, a DVD, a Blu-ray disc (registered trademark), and a semiconductor memory. The DVD is an abbreviation for “Digital Versatile Disk”. The medical processing program executed by the mobile terminal 3 may be provided by being installed via a network such as the Internet. In addition, the medical processing program executed by the mobile terminal 3 may be provided by being preinstalled into a ROM or the like in the device.

Operations Performed by Mobile Terminal Located within Wireless LAN of Hospital

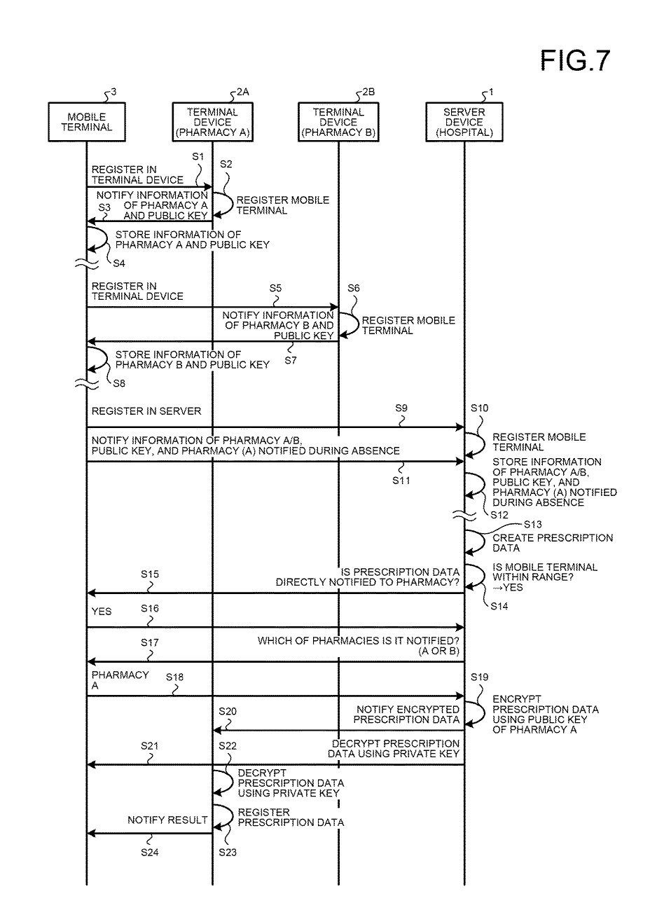

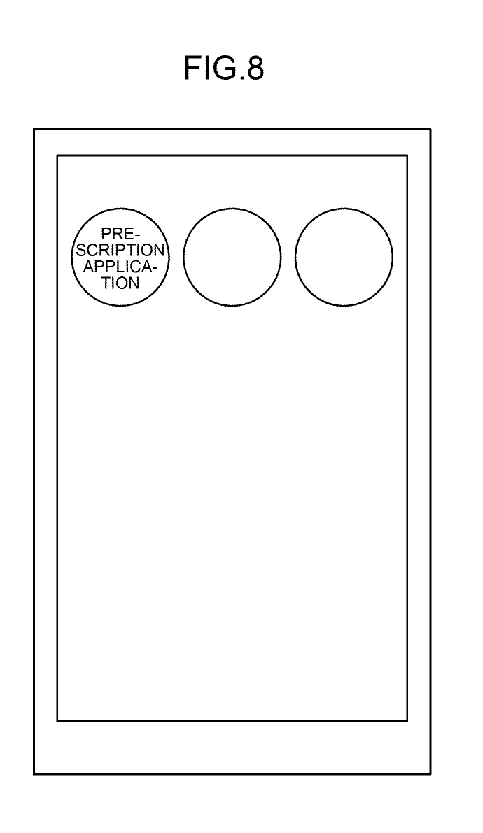

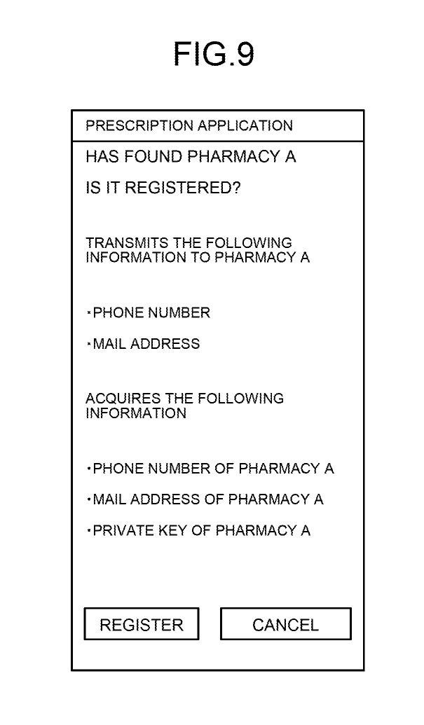

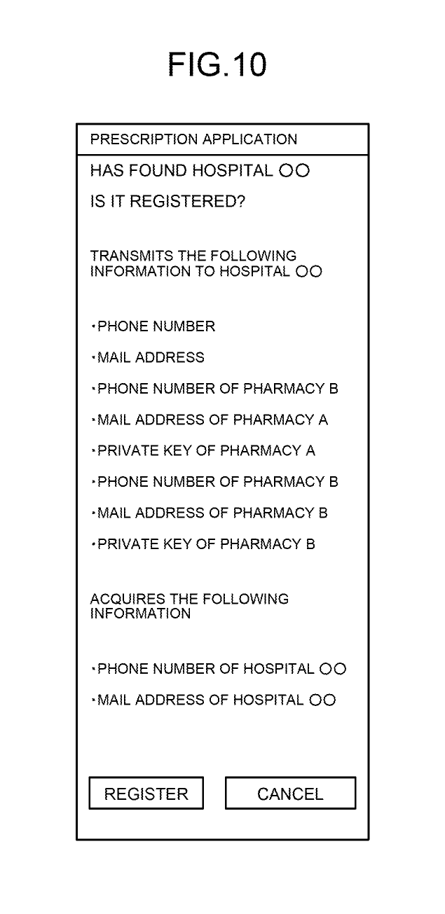

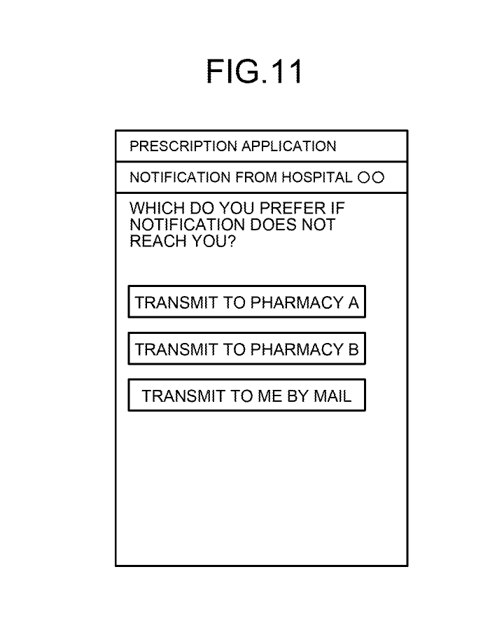

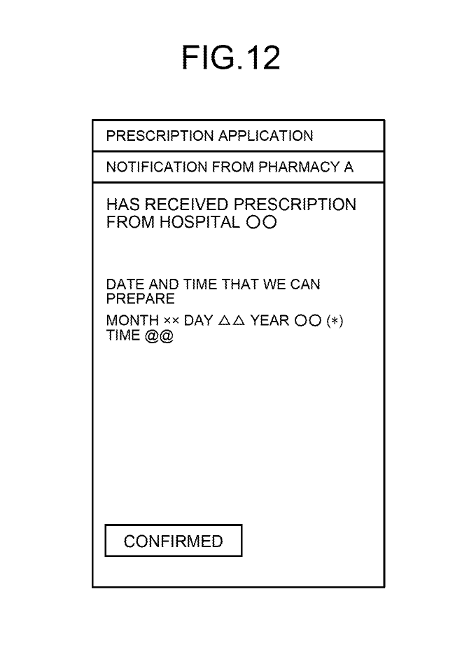

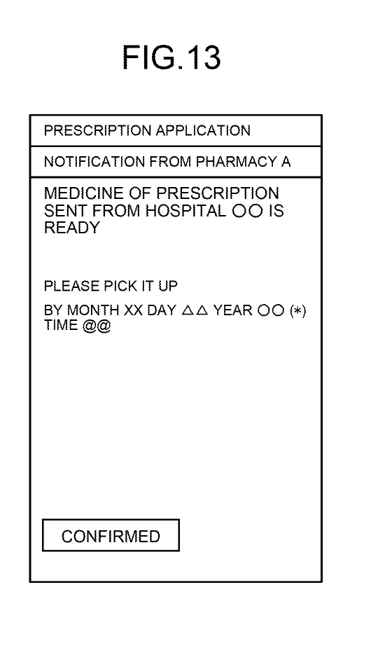

FIG. 7 is a sequence diagram illustrating a flow of communication performed by the mobile terminal 3 located within a predetermined network with the server device 1 of the hospital and with the terminal devices 2 of pharmacies. FIG. 8 is a diagram illustrating a screen example of the mobile terminal 3. FIG. 9 is a diagram illustrating a screen example of the mobile terminal 3 at the time of registering the mobile terminal 3 in the terminal device 2A of a pharmacy A. FIG. 10 is a diagram illustrating a screen example of the mobile terminal 3 at the time of registering the mobile terminal 3 in the server device 1 of the hospital. FIG. 11 is a diagram illustrating a selection screen for selecting processing for notification from the hospital when the mobile terminal 3 is located outside the predetermined network. FIG. 12 is a diagram illustrating a notification screen when the pharmacy A notifies the mobile terminal 3 of reception of the prescription from the hospital. FIG. 13 is a diagram illustrating a notification screen indicating that the medicine, notified to the mobile terminal 3 from the pharmacy A having received the prescription from the hospital, is ready (dispensing completed).

The flow of the communication performed by the mobile terminal 3 located within the predetermined network with the server device 1 of the hospital and with the terminal device 2 of the pharmacy will be explained below with reference to FIG. 7 to FIG. 13. The patient performs registration of mutual information between the pharmacy A, the pharmacy B, and the mobile terminal 3 (Step S1 to Step S4, Step S5 to Step S8).

In other words, when the patient performs an activation operation of, for example, a prescription application illustrated in FIG. 8, the CPU 31 of the mobile terminal 3 activates the medical processing program (=prescription application) stored in the RAM 33. The terminal device 2A of the pharmacy A transmits the terminal device information of the pharmacy A to the mobile terminal 3 when the mobile terminal 3 is located within the wireless LAN. The terminal receiving unit 62 of the mobile terminal 3 having received the terminal device information displays a selection screen for selecting whether the mobile terminal 3 should be registered in the terminal device 2A of the pharmacy A on the LCD 38. When the patient selects a button of “Register”, the mobile transmitting unit 61 transmits the mobile terminal information (phone number and mail address) to the terminal device 2A of the pharmacy A.

The mobile registering unit 51 of the terminal device 2A in the pharmacy A registers the mobile terminal information (phone number and mail address) of the mobile terminal 3 in the HDD 16. The terminal transmitting unit 54 of the terminal device 2A in the pharmacy A transmits the terminal device information such as the phone number, the mail address, and the public key, etc. of the pharmacy A to the mobile terminal 3. The terminal transmitting unit 54, which is an example of a notifying unit, notifies the corresponding mobile terminal 3 of reception of the prescription data from the server device 1 of the hospital. The terminal receiving unit 62 of the mobile terminal 3 receives the terminal device information of the pharmacy A and registers it in the HDD 16. For the public key of the terminal device 2, a pair of a public key and a private key used for asymmetric key encryption such as Rivest Shamir Adleman (RSA) is generated in advance and is stored in the terminal device 2.

Then, when the mobile terminal 3 of the patient is located within the wireless LAN at the time of receiving medical examination in the hospital, the server information of the server device 1 of the hospital is notified to the mobile terminal 3. The mobile terminal 3 and the server device 1 exchange their information to each other and register them therein respectively. In other words, the CPU 31 of the mobile terminal 3 having received the server information from the server device 1 displays, for example, a selection screen illustrated in FIG. 10 on the LCD 38 in order to select whether the mobile terminal 3 should be registered in the server device 1 of the hospital. When the patient selects the button of “Register”, the mobile transmitting unit 61 transmits the mobile terminal information (phone number and mail address) and the terminal device information (phone numbers, mail addresses, and public keys) of the pharmacies A and B acquired from the registered pharmacies A and B to the server device 1 of the hospital.

When the mobile terminal 3 is located outside the wireless LAN of the hospital (during absence), the CPU 31 of the mobile terminal 3 displays, for example, a selection screen illustrated in FIG. 11 on the LCD 38 in order to select processing for notification from the hospital. The button of “Transmit to Pharmacy A” illustrated in FIG. 11 is a button, when the mobile terminal 3 is located outside the wireless LAN of the hospital, used for selection at the time of specifying the pharmacy A as a destination of the notification from the hospital. The button of “Transmit to Pharmacy B” is a button, when the mobile terminal 3 is located outside the wireless LAN of the hospital, used for selection at the time of specifying the pharmacy B as a destination of the notification from the hospital. The button of “Transmit to me by mail” is a button, when the mobile terminal 3 is located outside the wireless LAN of the hospital, used for selection at the time of receiving the notification from the hospital by email. The mobile transmitting unit 61 transmits also absence information indicating the processing during absence selected by the patient included in the mobile terminal information to the server device 1 of the hospital (Step S9, Step S11). The mobile registering unit 40 of the server device 1 in the hospital registers the mobile terminal information received from the mobile terminal 3 in the HDD (Step S10, Step S12).

The following Table 1 represents main information indicating pharmacies each as a forwarding destination of the notification from the hospital, which are registered in the server device 1 of the hospital, when the mobile terminal 3 is located outside the wireless LAN of the hospital (during absence).

TABLE 1

| | | | Notification |
|---|---|---|---|
| Terminal | Pharmacy | Public Key | Flag |
| A001 | Pharmacy A | * * * | 1 |
| A001 | Pharmacy B | * * * * | 0 |
| A002 | Pharmacy C | * * * * | 1 |
| A002 | Pharmacy A | * * * * | 0 |
| A003 | Pharmacy B | * * * * | 1 |
| . | . | . | . |
| . | . | . | . |
| . | . | . | . |

As illustrated in Table 1, the server device 1 of the hospital stores identification information of mobile terminals 3 such as A001 and A002, information indicating pharmacies such as pharmacy A and pharmacy B registered in the mobile terminals 3, public keys of the pharmacies, notification flags, and so on. Table 1 indicates that in the case of the mobile terminal 3 of “A001”, the pharmacy A and the pharmacy B are registered and that when it is located outside the wireless LAN of the hospital (during absence), it is desired to forward the notification from the hospital to the pharmacy A whose notification flag is “1”. Likewise, Table 1 indicates that in the case of the mobile terminal 3 of “A002”, the pharmacy A and the pharmacy C are registered and when it is located outside the wireless LAN of the hospital (during absence), it is desired to forward the notification from the hospital to the pharmacy C whose notification flag is “1”.

Subsequently, when the prescription issued by a doctor is registered in the server device 1 after the medical examination in the hospital (Step S13), the server device 1 checks whether the mobile terminal 3 of the patient is located within the wireless LAN (Step S14). When the mobile terminal 3 of the patient is located within the wireless LAN, the server device 1 makes an inquiry to the pharmacy previously specified by the mobile terminal 3 as to whether the prescription data is to be notified, and makes an inquiry, when there is a plurality of specified pharmacies, which of them the prescription data is to be notified (Step S15, Step S17).

When obtaining a replay, in which the prescription data is to be notified and the pharmacy to which the prescription data is to be notified is specified, from the mobile terminal 3 (Step S16, Step S18), the server device 1 encrypts the prescription data using the public key of the specified pharmacy (Step S19). The server device 1 transmits the encrypted prescription data to the terminal device 2 of the specified pharmacy (Step S20). The server device 1 transmits the result notification indicating that the prescription data has been transmitted to the specified pharmacy to the mobile terminal 3 (Step S21). For example, when obtaining the reply, in which the prescription data is to be transmitted to the pharmacy A, from the patient, the server device 1 of the hospital encrypts the prescription data using the public key of the pharmacy A and transmits the encrypted prescription data to the terminal device 2A of the pharmacy A. The server device 1 transmits the result notification indicating that the prescription data has been transmitted to the pharmacy A to the mobile terminal 3.

When the mobile terminal 3 is located within the wireless LAN of the server device 1 of the hospital and the reply indicating that the prescription data is to be received by the mobile terminal 3 is obtained, the server device 1 of the hospital transmits the prescription data to the mobile terminal 3 without encryption. The wireless LAN of the hospital is a secure network. Therefore, even if the prescription data is to be transmitted to the mobile terminal 3 without encryption, the prescription data can be securely transmitted to the mobile terminal 3.

The prescription receiving unit 55 of the terminal device 2 of the hospital receives the encrypted prescription data from the server device 1 of the hospital. The prescription decrypting unit 56 decrypts the prescription data using the private key (Step S22), and the prescription registering unit 57 registers the decrypted prescription data in the HDD 16 (Step S23). The terminal device 2 of the pharmacy notifies the mobile terminal 3 of the patient that the prescription data has been received from the hospital (Step S24). At this time, an estimated time at which the dispensing will be completed as illustrated in FIG. 12 may be notified from the terminal device 2 of the pharmacy to the mobile terminal 3 of the patient. As illustrated in FIG. 13, the completion of the dispensing and the time period during which the medicine can be received and the like may be notified to the mobile terminal 3 of the patient.

Operations Performed by Mobile Terminal Located outside Wireless LAN of Hospital

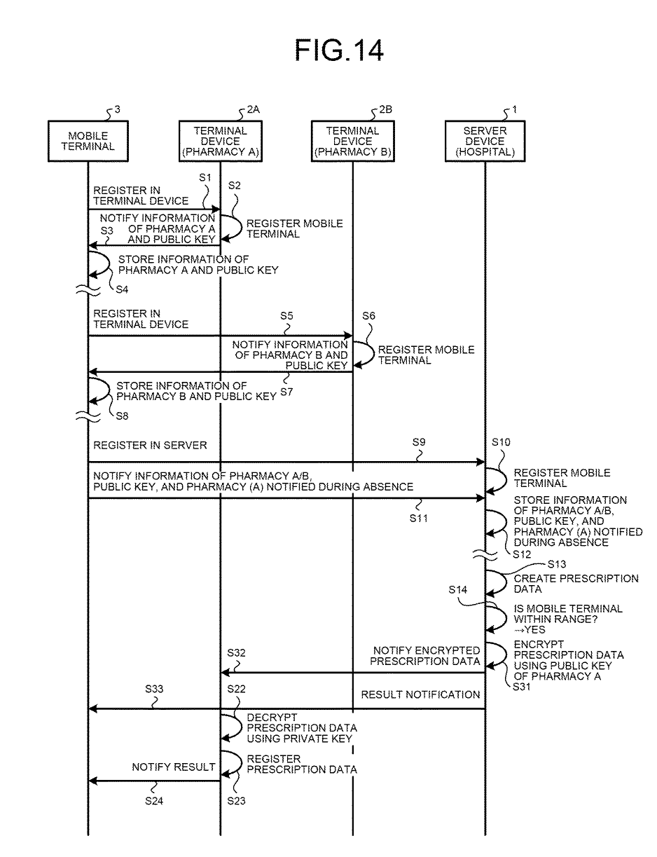

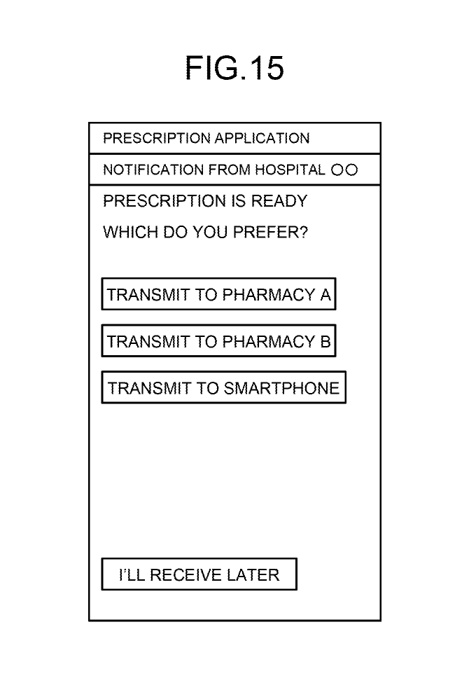

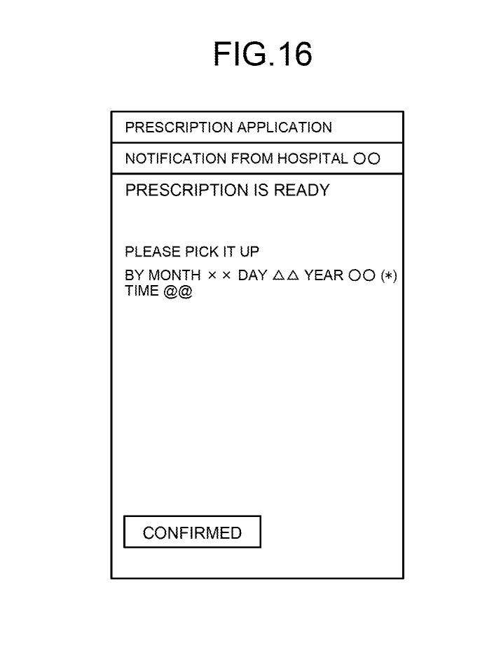

FIG. 14 is a sequence diagram illustrating a flow of communication performed by the mobile terminal 3 located outside the wireless LAN of the hospital with the server device of the hospital and with the terminal devices of the pharmacies. FIG. 15 is a diagram illustrating a selection screen used when the mobile terminal 3 located within the wireless LAN of the hospital selects the way to receive prescription data. FIG. 16 is a diagram illustrating a screen example of displaying a mail result for reception of the prescription data.

In the sequence diagram illustrated in FIG. 14, Step S1 to Step S14 and Step S22 to Step S24 are as explained in the sequence diagram of FIG. 7. See the explanation of the same step numbers in FIG. 7.

At Step S14 of the sequence diagram in FIG. 14, when the server device 1 of the hospital that generates the prescription data determines that the mobile terminal 3 is not present within the wireless LAN of the hospital, the server device 1 transmits, for example, the information of the selection screen for selecting the way to receive the prescription data illustrated in FIG. 15 to the mail address of the mobile terminal 3 of the patient.

The patient selects a desired way to receive the prescription data through the mobile terminal 3, and returns the result to the server device 1 of the hospital. For example, when the way to receive the prescription data by, for example, the pharmacy A is selected by the patient, the server device 1 encrypts the prescription data using the public key of the pharmacy A (Step S31), and transmits the encrypted prescription data to the terminal device 2A of the pharmacy A (Step S32). When the reception of the prescription data by the pharmacy A (or the pharmacy B) is selected, the server device 1 transmits the notification indicating that the prescription illustrated in FIG. 16 is ready to the mobile terminal 3 (Step S33).

When the way to receive the prescription data by the pharmacy B is selected by the patient, the server device 1 encrypts the prescription data using the public key of the pharmacy B, and transmits the encrypted prescription data to the terminal device 2B of the pharmacy B. When the way to receive the prescription data by the mobile terminal 3 of the patient is selected by the patient, the server device 1 encrypts the prescription data using the public key of the mobile terminal 3 of the patient, and transmits the encrypted prescription data to the mobile terminal 3 of the patient through the wireless LAN. The pharmacy A, the pharmacy B, or the mobile terminal 3 decrypts the encrypted prescription data using the private key and stores the decrypted data in the HDD 16 or in the RAM 33, etc. (Step S22 to Step S23).

Operations Performed by Mobile Terminal Located within Wireless LAN of Hospital

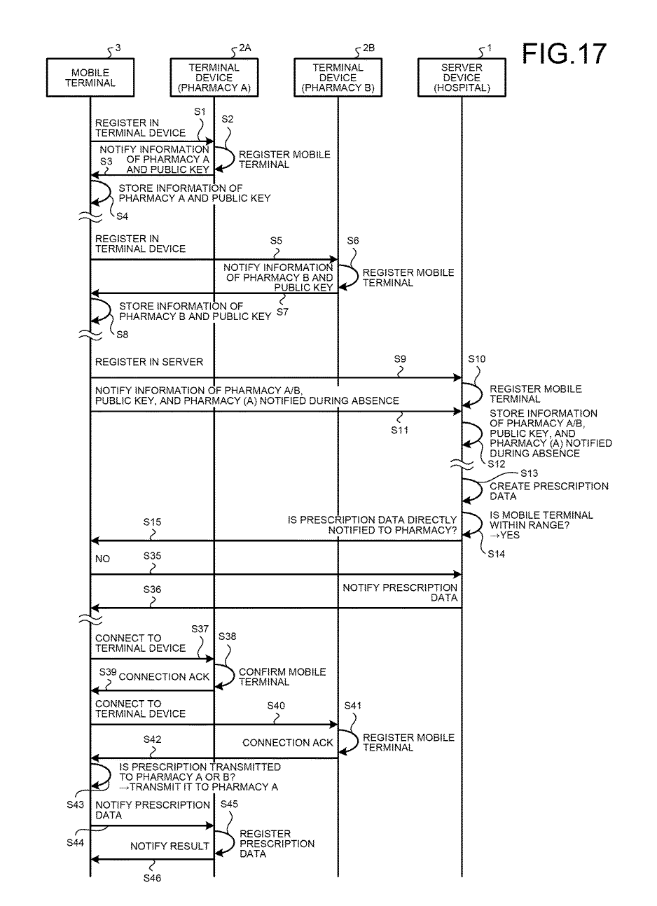

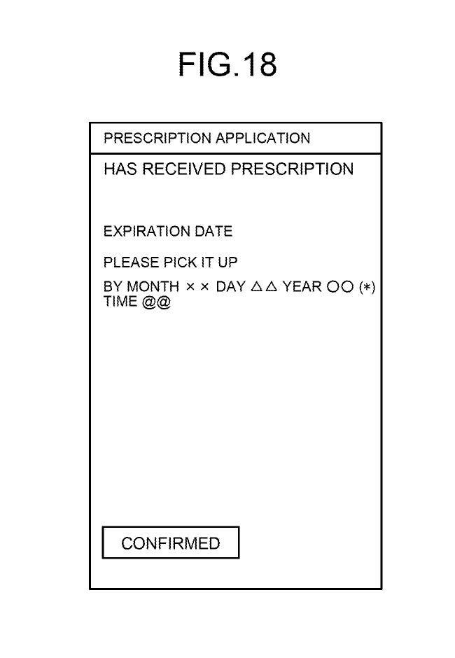

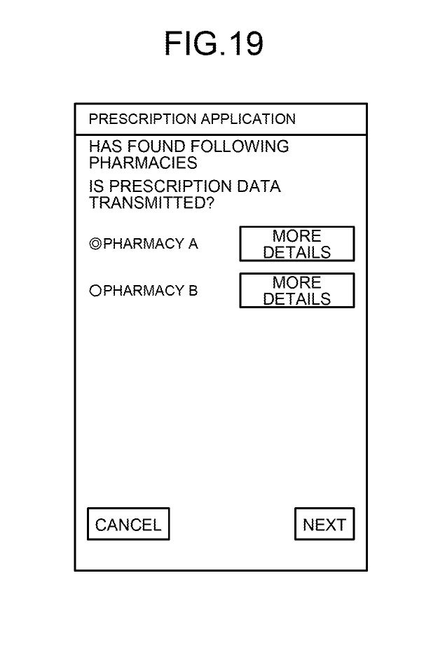

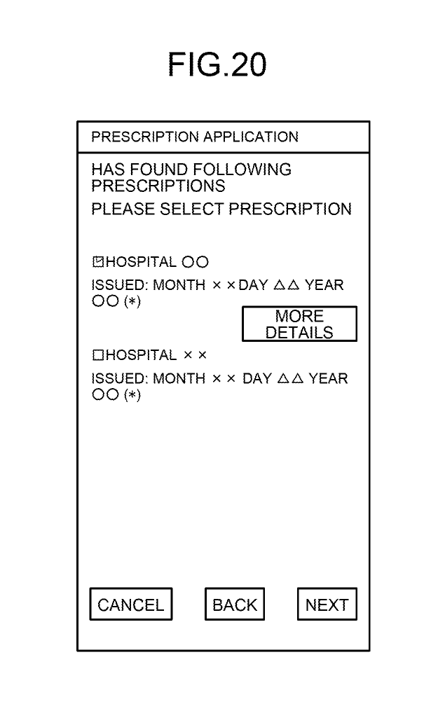

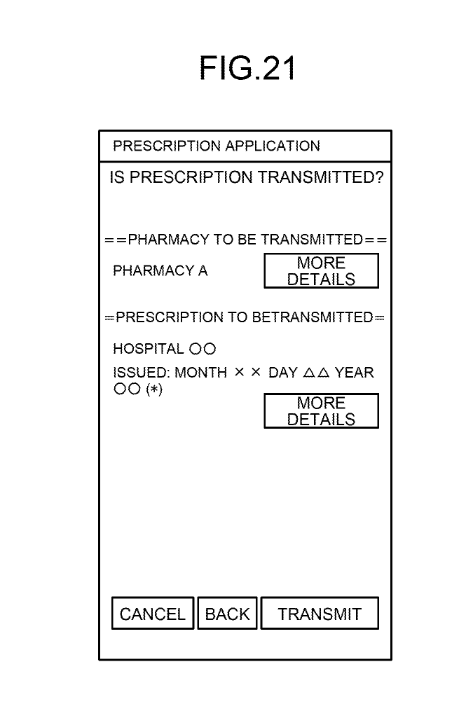

FIG. 17 is a sequence diagram illustrating a flow of transmission of the prescription data created by the hospital from the mobile terminal 3 to a desired pharmacy. FIG. 18 is a diagram illustrating a receipt notification screen of the mobile terminal having received the prescription data from the hospital. FIG. 19 is a diagram illustrating a selection screen of pharmacies within the wireless LAN where the mobile terminal is located. FIG. 20 is a diagram illustrating a selection screen of the prescription data to be transmitted to a pharmacy. FIG. 21 is a diagram illustrating an operation screen used to transmit the selected prescription data to the selected pharmacy.

In the sequence diagram illustrated in FIG. 17, Step S1 to Step S14 are as explained in the sequence diagram of FIG. 7. See the explanation of the same step numbers in FIG. 7.

First of all, as explained with reference to FIG. 15, the hospital creates the prescription of the patient, and makes an inquiry to the mobile terminal 3 of the patient located within the wireless LAN of the hospital about the way to receive the prescription (Step S15). When requesting a direct transmission of the prescription data from the hospital to the pharmacy, the patient specifies the pharmacy A or the pharmacy B as a desired pharmacy through the selection screen as explained with reference to FIG. 15 and transmits the specified one to the hospital. Thus, the server device 1 of the hospital encrypts the prescription data using the public key of the specified pharmacy and transmits the encrypted prescription data to the specified pharmacy.

On the other hand, when it is requested that the prescription data is temporarily received by the mobile terminal 3 and is forwarded to a desired pharmacy from the mobile terminal 3, the patient selects the way to receive the prescription such as “Transmit to smartphone” with respect to the inquiry (Step S15) about the way to receive the prescription from the hospital (Step S35). When this selection is made, the server device 1 of the hospital encrypts the prescription data using the public key of the mobile terminal 3 of the patient and transmits the encrypted prescription data to the mobile terminal 3 (Step S36). The prescription receiving unit 64 of the mobile terminal 3 decrypts the received prescription data using the private key and temporarily stores the decrypted prescription data in the RAM 33.

Subsequently, when the patient moves from the hospital to, for example, any place within the wireless LAN of a pharmacy, the CPU 31 of the mobile terminal 3 performs a wireless LAN communication connection to the terminal device 2 of the pharmacy as illustrated at Step S37 to Step S42. The example of FIG. 17 is an example in which the mobile terminal 3 performs the wireless LAN communication connection respectively to the terminal device 2A of the pharmacy A and to the terminal device 2B of the pharmacy B. The CPU 31 of the mobile terminal 3 displays a list of the pharmacies corresponding to the terminal device to which the wireless LAN communication connection is performed as illustrated in FIG. 19. The example of FIG. 19 is an example in which the mobile terminal 3 performs the wireless LAN communication connection respectively to the terminal device 2A and to the terminal device 2B. The patient selects a pharmacy, from the list of the pharmacies, to which the prescription data received from the hospital is to be forwarded (Step S43).

When the pharmacy to which the prescription data is to be forwarded is selected, the CPU 31 of the mobile terminal 3 displays a selection screen of the prescription data to be forwarded as illustrated in FIG. 20. The example of FIG. 20 is an example in which the prescription data sent from two hospitals are stored in the RAM 33. The patient selects the prescription data to be forwarded from among the list of the prescription data.

As illustrated in FIG. 21, the CPU 31 of the mobile terminal 3 displays a transmission button on the LCD 38 along with the hospital and the prescription data selected by the patient for confirmation. The example of FIG. 21 represents an example in which the pharmacy A is selected as a forwarding destination of the prescription data and the prescription data received from hospital OO is selected as the prescription data to be forwarded. The patient confirms the display content and operates the transmission button. When the transmission button is operated, the mobile transmitting unit 61 of the mobile terminal 3 transmits the selected prescription data to the terminal device 2 of the selected pharmacy (Step S44).

For example, when the prescription data is transmitted to the pharmacy A, the terminal device 2A of the pharmacy A registers the prescription data in the HDD 16 (Step S45), and transmits the receipt notification of the prescription data, for example, similar to that of FIG. 18 to the mobile terminal 3 (Step S46).

As apparent from the above explanation, in the medical information processing system according to the first embodiment, the server device 1 of the hospital acquires the mobile terminal information (phone number, mail address) of the mobile terminal 3 of the patient and the terminal device information (phone number, mail address, and public key) of each pharmacy. When the mobile terminal 3 of the patient is connected to the network of the hospital, the server device 1 of the hospital transmits the prescription data encrypted by using the public key of the patient to the mobile terminal 3 of the patient. When the mobile terminal 3 of the patient is not connected to the server device 1 of the hospital, the server device 1 of the hospital transmits the prescription data encrypted by using the public key of the pharmacy to the terminal device 2 of the pharmacy previously specified by the patient. This allows easy and secure delivery of the prescription data between terminals of hospitals, pharmacies, and the patient without constructing a secure network between the terminals of hospitals, pharmacies, and the patient.

### Second Embodiment

A medical information processing system according to a second embodiment will be explained next. The medical information processing system according to the second embodiment is a system for transmission and reception of prescription data via a cloud server device connected to a predetermined network such as the Internet. In other words, the medical information processing system is a system in which the cloud server device relays prescription data to be transmitted and received. The second embodiment is different from the first embodiment only in a point that the second embodiment is configured to transmit and receive prescription data through the cloud server device. Therefore, only a difference between the both embodiments will be explained below, and the overlapping explanation is omitted.

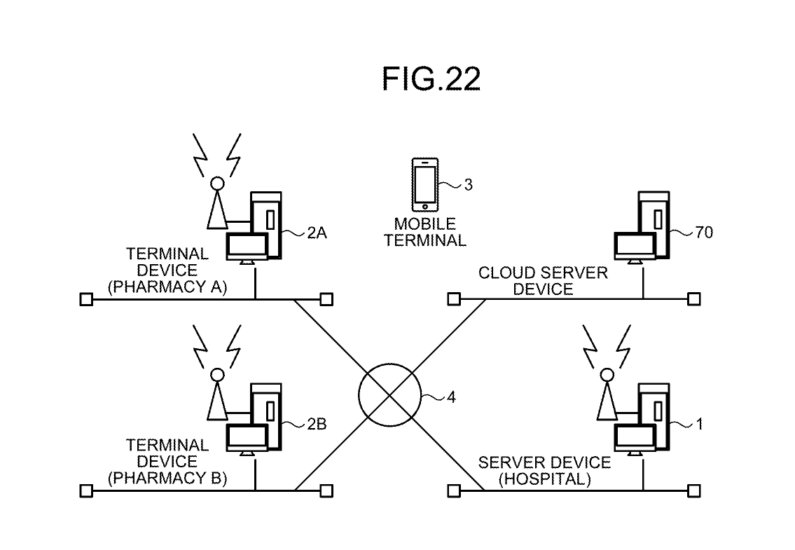

FIG. 22 is a system configuration diagram of the medical information processing system according to the second embodiment. As illustrated in FIG. 22, the second embodiment is configured to further include a cloud server device 70 connected to the network 4. The cloud server device 70 is an example of a relay terminal device.

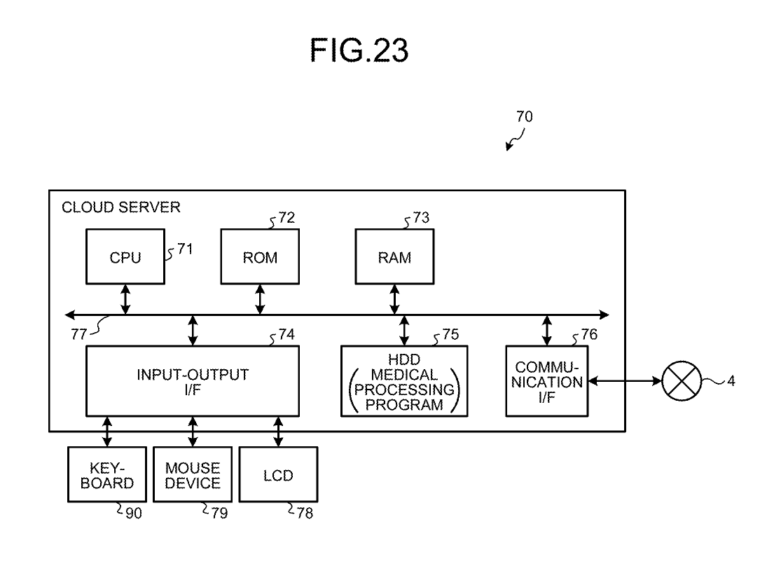

FIG. 23 is a hardware configuration diagram of the cloud server device 70. As illustrated in FIG. 23, the cloud server device 70 includes a CPU 71, a ROM 72, a RAM 73, an input-output I/F 74, a HDD 75, and a communication I/F 76. The CPU 71 through the communication I/F 76 are connected to each other through a system bus 77. The input-output I/F 74 is connected with a keyboard 90, a mouse device 79, and an LCD 78.

The HDD 16 stores the medical processing program. The CPU 71 executes the medical processing program and can thereby securely transmit and receive prescription data, etc., which will be explained later, between a hospital, pharmacies, and a patient.

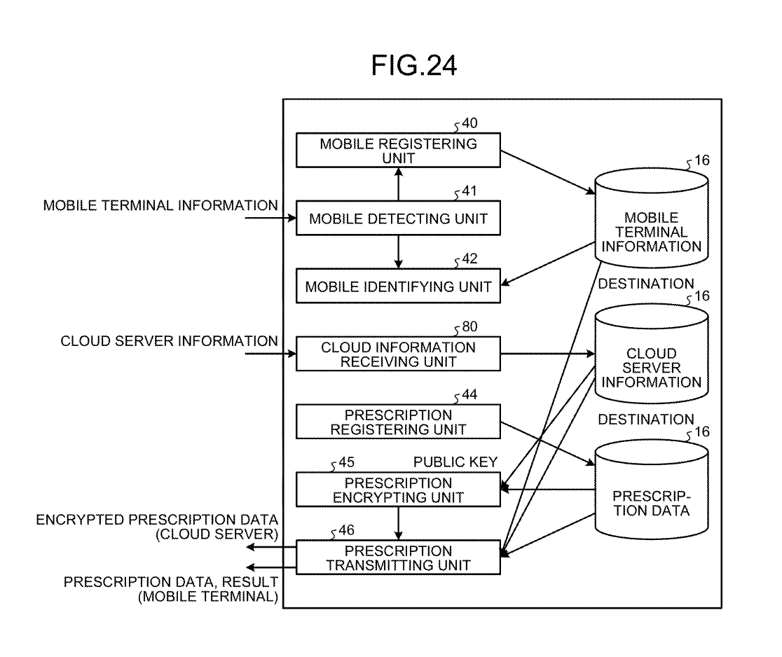

FIG. 24 is a functional block diagram of the server device 1 in the hospital side provided in the medical information processing system according to the second embodiment. The server device 1 according to the second embodiment is configured to further include a cloud information receiving unit 80, as illustrated in FIG. 24, along with the mobile registering unit 40 through the prescription transmitting unit 46. The prescription transmitting unit 46 is an example of a first-facility transmitting unit.

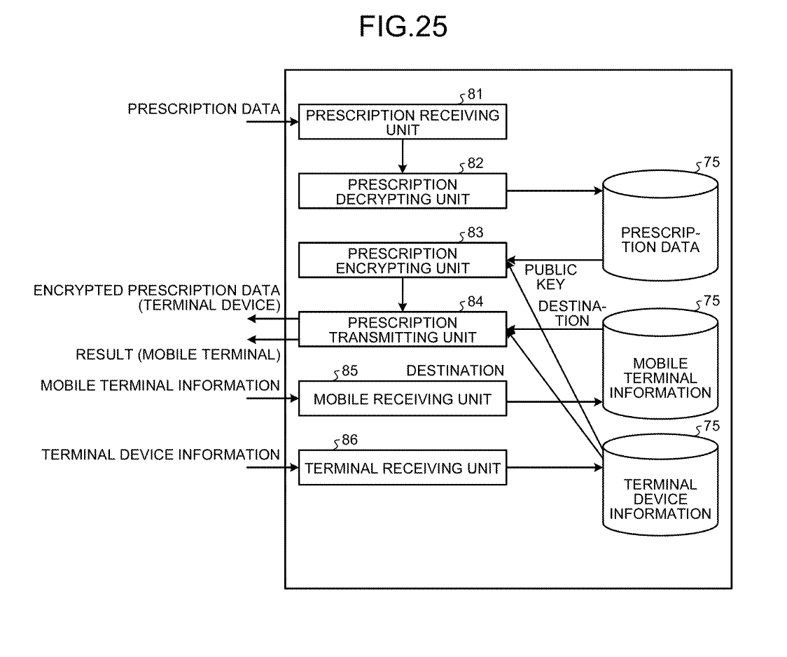

FIG. 25 is a functional block diagram of the cloud server device 70. The CPU 71 of the cloud server device 70 executes the medical processing program stored in the HDD 75 to thereby function as a prescription receiving unit 81 and a prescription decrypting unit 82 illustrated in FIG. 25. The prescription decrypting unit 82 is an example of a relay terminal decrypting unit. The CPU 71 also executes the medical processing program to thereby function as a prescription encrypting unit 83, a prescription transmitting unit 84, a mobile receiving unit 85, and a terminal receiving unit 86. The prescription encrypting unit 83 is an example of a relay terminal encrypting unit. The terminal receiving unit 86 is an example of a relay terminal transmitting unit.

The prescription receiving unit 81 receives the encrypted prescription data from the outside. The prescription decrypting unit 82 decrypts the received prescription data using the private key of the cloud server device 70, and stores the decrypted prescription data in the HDD 75. The prescription encrypting unit 83 encrypts the prescription data read from the HDD 75 using the public key of the terminal device 2 of a pharmacy. The prescription transmitting unit 84 transmits the encrypted prescription data to a predetermined pharmacy and transmits the transmission result to the mobile terminal 3 of the patient. The mobile receiving unit 85 receives the mobile terminal information from the outside and stores it in the HDD 75. The terminal receiving unit 86 receives the terminal device information of the terminal device 2 of the pharmacy and stores it in the HDD 75.

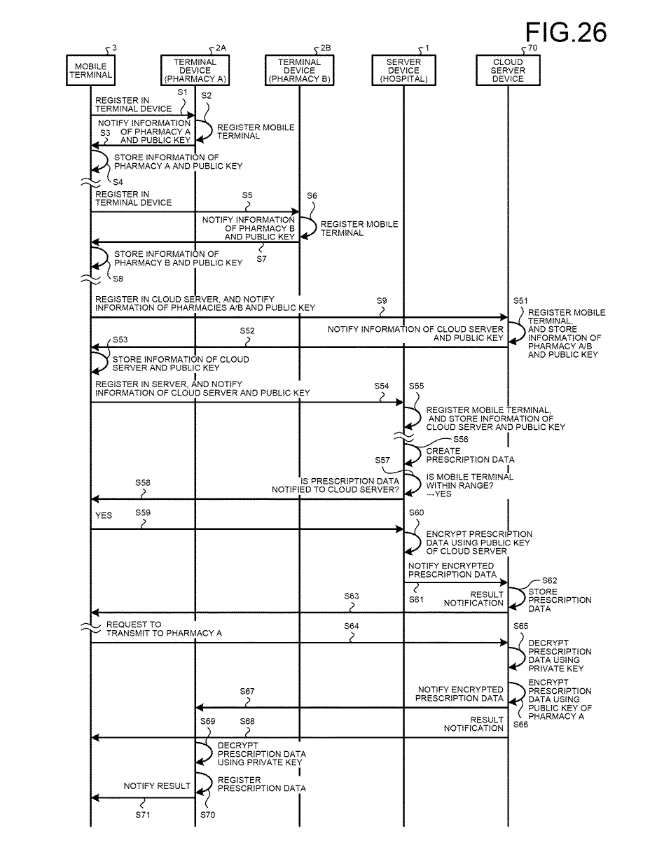

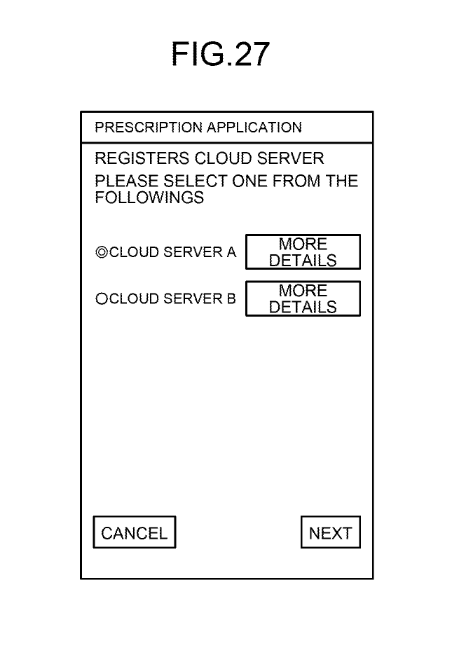

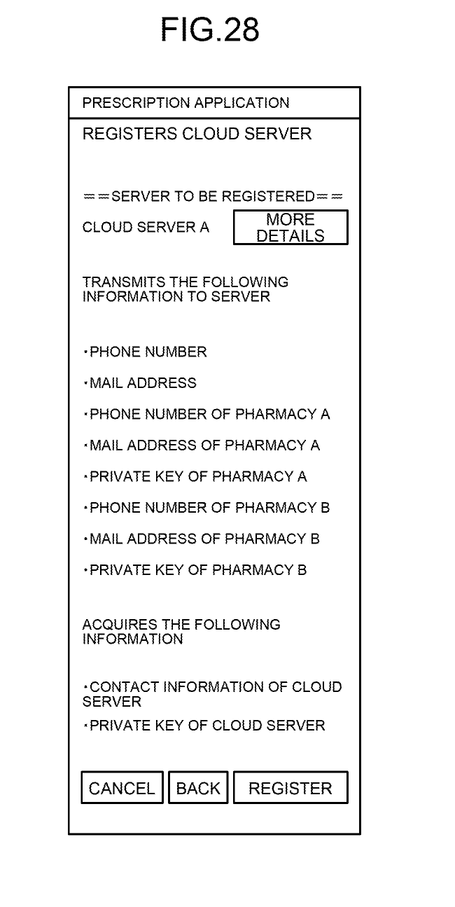

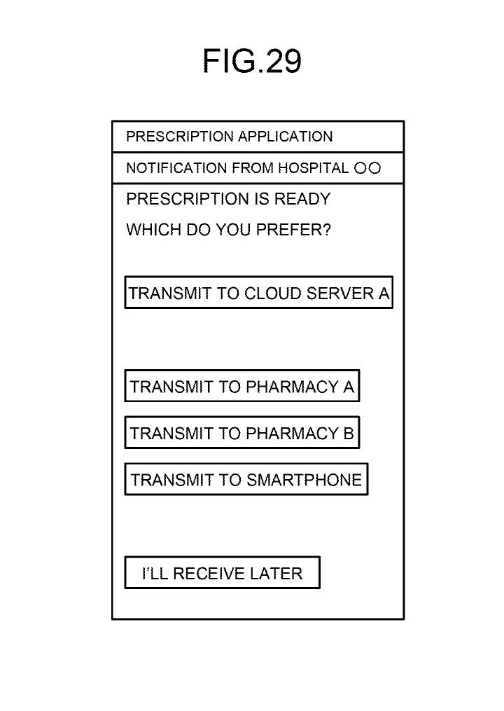

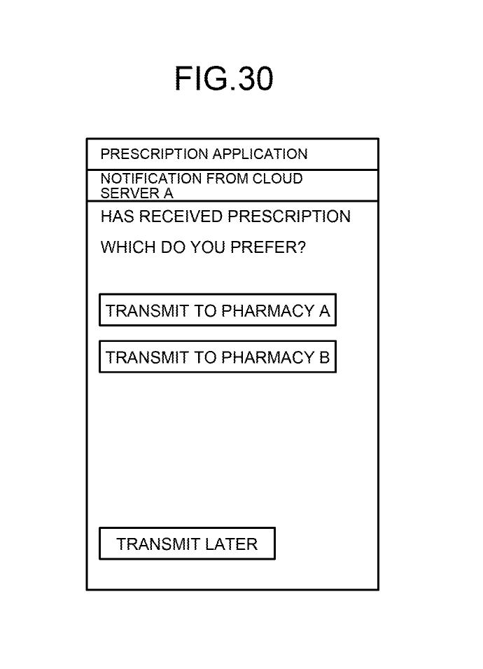

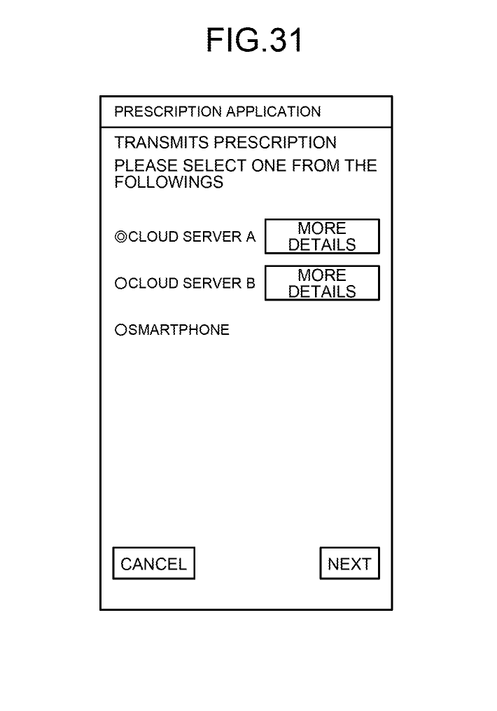

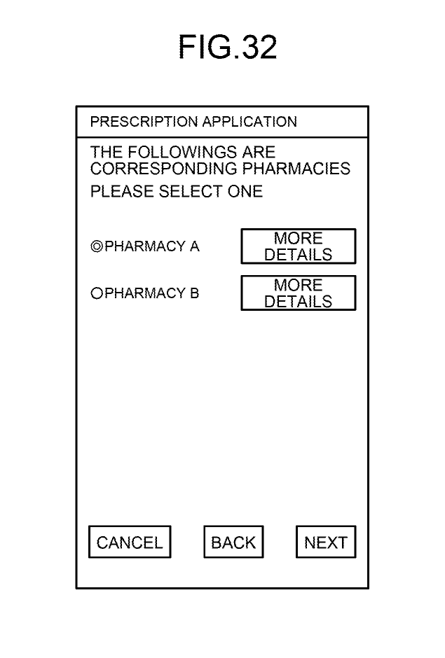

FIG. 26 is a sequence diagram illustrating a flow of transmission of prescription data to the terminal device 2A of the pharmacy A via the cloud server device 70. FIG. 27 is a diagram illustrating a selection screen of the cloud server device 70. FIG. 28 is a diagram illustrating a registration confirmation screen of the cloud server device 70. FIG. 29 is a diagram illustrating a selection screen for a destination of prescription data. FIG. 30 is a diagram illustrating a selection screen for a pharmacy as a destination of prescription data requested to the cloud server device 70. FIG. 31 is a diagram illustrating a confirmation screen of the cloud server device 70 to which transmission of the prescription data is requested. FIG. 32 is a diagram illustrating a confirmation screen of a pharmacy to which the prescription data is transmitted from the cloud server device 70.

When the prescription data is to be transmitted to a desired pharmacy from the cloud server device 70, the cloud server device 70 to be used is registered first. In other words, when the patient operates the mobile terminal 3 to specify registration of the cloud server devices 70, the CPU 31 displays the registration screen of the cloud server device 70 illustrated in FIG. 27 on the LCD 38. The patient selects a desired cloud server device 70 from the cloud server devices 70 listed in the registration screen. When the desired cloud server device 70 is selected, the CPU 31 of the mobile terminal 3 displays the registration confirmation screen illustrated in FIG. 28. When a registration instruction button in the registration confirmation screen is operated by the patient, then at Step S9 in the sequence diagram of FIG. 26, the CPU 31 notifies the cloud server device 70 of the mobile terminal information (phone number and mail address) of the mobile terminal 3 of the patient and of the terminal device information (phone number, mail address, and public key) of each pharmacy (A, B). The mobile receiving unit 85 of the cloud server device 70 stores the mobile terminal information notified from the mobile terminal 3 in the HDD 75 (Step S51). The terminal receiving unit 86 of the cloud server device 70 stores the terminal device information notified from the mobile terminal 3 in the HDD 75 (Step S51).

The cloud server device 70 stores the mobile terminal information and the terminal device information, and then transmits cloud server information (contact information and public key) to the mobile terminal 3 (Step S52). The terminal receiving unit 62 of the mobile terminal 3 stores the cloud server information in the RAM 33 (Step S53). The terminal receiving unit 62 is an example of a user terminal acquiring unit.

The CPU 31 of the mobile terminal 3 transmits the cloud server information to the server device 1 of the hospital (Step S54). The cloud information receiving unit 80 of the server device 1 of the hospital stores the received cloud server information in the HDD 16 (Step S55).

The following Table 2 represents an example of the cloud server information stored in the server device 1 of the hospital.

TABLE 2

| Terminal | Server | Public Key |
|---|---|---|
| A001 | A | * * * |
| A002 | B | * * * |
| A003 | C | * * * |
| . | . | . |
| . | . | . |
| . | . | . |

As illustrated in Table 2, the server device 1 of the hospital stores the identification information of the mobile terminal 3, the contact information of the cloud server device, and the public key of the cloud server device in association with each other.

Subsequently, when the prescription data of the patient is created by the hospital (Step S56), the server device 1 of the hospital determines whether the mobile terminal 3 is located within the wireless LAN of the server device 1 (Step S57). When the mobile terminal 3 is located within the wireless LAN of the server device 1, the server device 1 transmits the information in the selection screen for the destination of the prescription data illustrated in FIG. 29 to the mobile terminal 3 (Step S58). When “Transmit to cloud server device A” is selected by the patient through the selection screen (Step S59), the server device 1 of the hospital encrypts the prescription data using the public key of the cloud server device 70 (cloud server device A) (Step S60), and transmits the encrypted prescription data to the cloud server device 70 (Step S61). The prescription receiving unit 81 of the cloud server device 70 receives the prescription data and temporarily stores it in the HDD 75 (Step S62).

Subsequently, the cloud server device 70 transmits the information for the selection screen of the pharmacy as a destination to the mobile terminal 3 along with the notification indicating that the prescription data has been received from the hospital as illustrated in FIG. 30 (Step S63). The patient selects the desired pharmacy as a destination of the prescription data and notifies the cloud server device 70 of the desired pharmacy (Step S64). As an example, the explanation will be continued assuming that the pharmacy A is specified as the destination of the prescription data.

When the pharmacy A is specified as the destination, the cloud server device 70 decrypts the prescription data received from the hospital using the private key of the cloud server device 70 (Step S65), and the prescription encrypting unit 83 encrypts the decrypted prescription data using the public key of the pharmacy A specified by the patient (Step S66) and transmits the encrypted prescription data to the terminal device 2A of the pharmacy A (Step S67). The cloud server device 70 also transmits the notification indicating that the prescription data has been notified to the pharmacy A to the mobile terminal 3 (Step S68).

The terminal device 2A of the pharmacy A having received the prescription data from the cloud server device 70 decrypts the prescription data using the private key of the pharmacy A (Step S69), and stores the decrypted prescription data in the HDD 16 (Step S70). The terminal transmitting unit 54 of the terminal device 2A of the pharmacy A transmits the notification indicating that the prescription data illustrated in FIG. 12 has been received from the cloud server device 70 to the mobile terminal 3 (Step S71). The terminal transmitting unit 54 is an example of a second-facility notifying unit.

On the other hand, when “Transmit later” is selected in the selection screen of the pharmacy in FIG. 30, it is necessary to perform an operation of actively transmitting the prescription data from the mobile terminal 3. In this case, as illustrated in FIG. 31, it may be configured so that the patient will select a desired cloud server device. Alternatively, the prescription data stored in the mobile terminal 3 may be selected. In this case, the processing is performed in the same flow as that of FIG. 19, FIG. 20, and FIG. 21, however, the range of the wireless LAN is not detected as the selection screen, and the selection screen of the terminal device 2 in each pharmacy stored by the cloud server device 70 has only to be displayed as illustrated in FIG. 32.

Even in the case of the medical information processing system according to the second embodiment, the same effects as these in the first embodiment can be obtained.

According to the present embodiments, it is possible to construct the information processing system capable of transmitting and receiving digitized medical information, etc. easily and securely.

The above-described embodiments are illustrative and do not limit the present invention. Thus, numerous additional modifications and variations are possible in light of the above teachings. For example, at least one element of different illustrative and exemplary embodiments herein may be combined with each other or substituted for each other within the scope of this disclosure and appended claims. Further, features of components of the embodiments, such as the number, the position, and the shape are not limited the embodiments and thus may be preferably set. It is therefore to be understood that within the scope of the appended claims, the disclosure of the present invention may be practiced otherwise than as specifically described herein.

The method steps, processes, or operations described herein are not to be construed as necessarily requiring their performance in the particular order discussed or illustrated, unless specifically identified as an order of performance or clearly identified through the context. It is also to be understood that additional or alternative steps may be employed.

Further, any of the above-described apparatus, devices or units can be implemented as a hardware apparatus, such as a special-purpose circuit or device, or as a hardware/software combination, such as a processor executing a software program.

Further, as described above, any one of the above-described and other methods of the present invention may be embodied in the form of a computer program stored in any kind of storage medium. Examples of storage mediums include, but are not limited to, flexible disk, hard disk, optical discs, magneto-optical discs, magnetic tapes, nonvolatile memory, semiconductor memory, read-only-memory (ROM), etc.

Alternatively, any one of the above-described and other methods of the present invention may be implemented by an application specific integrated circuit (ASIC), a digital signal processor (DSP) or a field programmable gate array (FPGA), prepared by interconnecting an appropriate network of conventional component circuits or by a combination thereof with one or more conventional general purpose microprocessors or signal processors programmed accordingly.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA) and conventional circuit components arranged to perform the recited functions.

What is claimed is:

1. An information processing system comprising at least a first-facility terminal device of a first facility and a user terminal device of a user of the first facility, wherein
the first-facility terminal device is configured to include:
a first-facility encrypting unit configured to encrypt issuance information issued by the first facility using a public key acquired from the user terminal device, and
a first-facility terminal transmitting unit configured to transmit, when the user terminal device is connected to a network to which the first-facility terminal device is connected, the issuance information without encryption to the user terminal device, and to transmit, when the user terminal device is not connected to the network, the encrypted issuance information to the user terminal device, and
the user terminal device is configured to include:
a user-terminal transmitting unit configured to transmit the public key of the user terminal device to the first-facility terminal device,
a user-terminal receiving unit configured to receive the issuance information not encrypted or the encrypted issuance information transmitted from the first-facility terminal device, and
a user-terminal decrypting unit configured to decrypt the encrypted issuance information using a private key that is paired with the public key.

2. The information processing system according to claim 1, further comprising:
a second-facility terminal device of a second facility, wherein
the second-facility terminal device is configured to include:
a second-facility terminal transmitting unit configured to transmit a public key of the second-facility terminal device to the user terminal device,
a second-facility decrypting unit configured to decrypt the issuance information, which is encrypted by the first-facility terminal device using the public key of the second-facility terminal device, using a private key that is paired with the public key of the second-facility terminal device, and
a notifying unit configured to notify the user terminal device that the issuance information is received from the first-facility terminal device, and
the user terminal device is configured to further include a public key acquiring unit configured to acquire the public key of the second-facility terminal device, wherein
the user-terminal transmitting unit of the user terminal device is configured to transmit the public key of the user terminal device and the acquired public key of the second-facility terminal device to the first-facility terminal device.

3. The information processing system according to claim 2, wherein, when the user terminal device is not connected to the network and the second-facility terminal device is specified as a destination of the issuance information,
the first-facility terminal device is configured to encrypt the issuance information using the public key of the second-facility terminal device and transmit the encrypted issuance information to the second-facility terminal device,
the second-facility decrypting unit of the second-facility terminal device is configured to decrypt the issuance information using the private key that is paired with the public key of the second-facility terminal device, and
the notifying unit of the second-facility terminal device is configured to notify the user terminal device that the issuance information is received from the first-facility terminal device.

4. A server device that is a first-facility terminal device configured to transmit issuance information issued by a first facility to a user terminal device of a user of the first facility, comprising:
a first-facility encrypting unit configured to encrypt the issuance information issued by the first facility using a public key acquired from the user terminal device, and
a first-facility terminal transmitting unit configured to transmit, when the user terminal device is connected to a network to which the first-facility terminal device is connected, the issuance information without encryption to the user terminal device, and to transmit, when the user terminal device is not connected to the network, the encrypted issuance information to the user terminal device.

5. The server device according to claim 4, wherein, when the user terminal device is not connected to the network and a second-facility terminal device is specified as a destination of the issuance information,
the first-facility terminal transmitting device is configured to encrypt the issuance information using a public key of the second-facility terminal device and transmit the encrypted issuance information to the second-facility terminal device.

6. A non-transitory computer-readable medium comprising computer readable program codes, performed by a processor, the program codes when executed causing the processor to execute:
encrypting issuance information issued by a first facility using a public key acquired from a user terminal device, and
transmitting, when the user terminal device is connected to a network to which a first-facility terminal device is connected, the issuance information without encryption to the user terminal device, and transmitting, when the user terminal device is not connected to the network, the encrypted issuance information to the user terminal device.

7. The non-transitory computer-readable medium according to claim 6, wherein, when the user terminal device is not connected to the network and a second-facility terminal device is specified as a destination of the issuance information,
the transmitting includes encrypting the issuance information using a public key of the second-facility terminal device and transmitting the encrypted issuance information to the second-facility terminal device.
